(19) United States
(12) Patent Application Publication
(10) Pub. No.: US 2026/0331813 A1
(43) Pub. Date: Oct. 22, 2026

(54) FEMALE CONNECTOR AND MALE CONNECTOR

(71) Applicant: BIZLINK INTERNATIONAL CORP., New Taipei City (TW)

(72) Inventor: Zhongming LIN, New Taipei City (TW)

(21) Appl. No.: 19/653,148

(22) Filed: Apr. 21, 2026

(30) Foreign Application Priority Data
Apr. 21, 2025 (CN) 202520751780.7

(51) Int. Cl. H01R 13/424

(52) U.S. Cl. CPC H01R 13/424

(57) ABSTRACT

A female connector includes a female housing. The female housing includes a first terminal support, a second terminal support, a third terminal support, and a plurality of signal terminals. The second terminal support is disposed adjacent to the first terminal support. The third terminal support is connected to the first terminal support and the second terminal support. A bottom portion of the third terminal support extends laterally on two sides to form a first extension plate and a second extension plate, the first extension plate is disposed above first terminal support, and the second extension plate is disposed above the second terminal support. A plurality of signal terminals includes a first signal terminal disposed above the first extension plate and a second signal terminal disposed above the second extension plate.

### CROSS-REFERENCE TO RELATED APPLICATION

This application claims priority to Chinese Application Serial Number 202520751780.7, filed Apr. 21, 2025, which is herein incorporated by reference in its entirety.

### BACKGROUND

### Field of Invention

The present disclosure relates to the field of connector technology, particularly to a female connector and a male connector.

### Description of Related Art

An electrical connector is an electromechanical system that provides separable interfaces for connecting two sub-electronic systems. An electrical connector is configured to bridge two conductors in a circuit such that electrical current or signals can be transmitted from one conductor to another, thereby serving as a fundamental component for achieving electrical connection and signal transmission.

An electrical connector generally includes a power connector having line, neutral, and ground terminals for supplying electrical power, and a signal connector having signal terminals for transmitting signals. Currently, power connectors and signal connectors are usually used separately. This means that when a device requires both power supply and signal transmission, installation spaces for both a power connector and a signal connector are required, causing the electrical connector to occupy excessive space in the device and affecting circuit layout design.

### SUMMARY

The main objective of the present disclosure is to propose a female connector and a male connector, which have both power transmission and signal transmission functions, thereby reducing the space occupied by the connectors within a device.

One aspect of the present disclosure is to provide a female connector. The female connector includes a female housing. The female housing includes a first terminal support, a second terminal support, a third terminal support, and a plurality of signal terminals. The second terminal support is disposed adjacent to the first terminal support. The third terminal support is connected to the first terminal support and the second terminal support. A bottom portion of the third terminal support extends laterally on two sides to form a first extension plate and a second extension plate, the first extension plate is disposed above first terminal support, and the second extension plate is disposed above the second terminal support. A plurality of signal terminals includes a first signal terminal disposed above the first extension plate and a second signal terminal disposed above the second extension plate.

One aspect of the present disclosure is to provide a male connector. The male connector includes a male housing, a plurality of conductive terminals, and a plurality of signal terminals. The male housing includes a first terminal cavity, a second terminal cavity, and a third terminal cavity. The second terminal cavity is arranged beside the first terminal cavity. The third terminal cavity is communicated with the first terminal cavity and the second terminal cavity. The plurality of conductive terminals includes a first conductive terminal disposed in the first terminal cavity, a second conductive terminal disposed in the second terminal cavity, and a third conductive terminal disposed in the third terminal cavity. The plurality of signal terminals includes a first signal terminal and a second signal terminal in the third terminal cavity, wherein the first signal terminal and the second signal terminal are disposed on opposite sides of the third conductive terminal.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a female connector according to some embodiments of the present disclosure;

FIG. 2 is a schematic view of the female connector in FIG. 1;

FIG. 3 is a side view of the female connector in FIG. 1;

FIG. 4 is a cross-sectional view of the female connector taken along line A-A′ in FIG. 3;

FIG. 5 is a cross-sectional view of the female connector taken along line B-B′ in FIG. 3;

FIG. 6 is a cross-sectional view of the female connector taken along line C-C′ in FIG. 3;

FIG. 7 is a schematic view of the female connector in FIG. 1, in which the housing is omitted and the bottom surface is shown;

FIG. 8 is a side view of the female connector in FIG. 1, in which the housing, the first signal terminal, and the second signal terminal are omitted;

FIG. 9 is a side view of the female connector in FIG. 1, in which the housing, the first signal terminal, and the second signal terminal are omitted;

FIG. 10 is a schematic view of a male connector according to some embodiments of the present disclosure;

FIG. 11 is a schematic view of the male connector in FIG. 10;

FIG. 12 is a side view of the male connector in FIG. 10; and

FIG. 13 is a cross-sectional view of the male connector taken along line D-D′ in FIG. 12.

### DETAILED DESCRIPTION

In the description of the embodiments of the present disclosure, it should be understood that the orientations or positional relationships indicated are based on the orientations or positional relationships shown in the drawings, or the orientations or positional relationships conventionally used when the product of the present disclosure is in use, or the orientations or positional relationships conventionally understood by those skilled in the art. Such indications are merely for convenience of describing the present disclosure and to simplify the description, and are not intended to indicate or imply that the devices or elements referred to must have a specific orientation, be constructed in a specific orientation, or operate in a specific orientation. Therefore, they should not be construed as limiting the present disclosure.

In addition, if descriptions involving “first,” “second,” “third,” etc., are involved in the embodiments of the present disclosure, the descriptions of “first,” “second,” “third,” etc., are for descriptive purposes only and should not be understood as indicating or implying their relative importance or implicitly indicating the number of indicated technical features. Thus, a feature defined by “first” or “second” may explicitly or implicitly includes one or more than one such feature.

When a number or numerical range is described using terms such as “about,” “approximately,” “substantially,” or other similar expressions, such terms are intended to encompass values within a reasonable range of the recited value, as would be understood by a person having ordinary skill in the art, for example within ±10% of the recited value. For example, the term “about 5 mm” encompasses a size range from 4.5 mm to 5.5 mm.

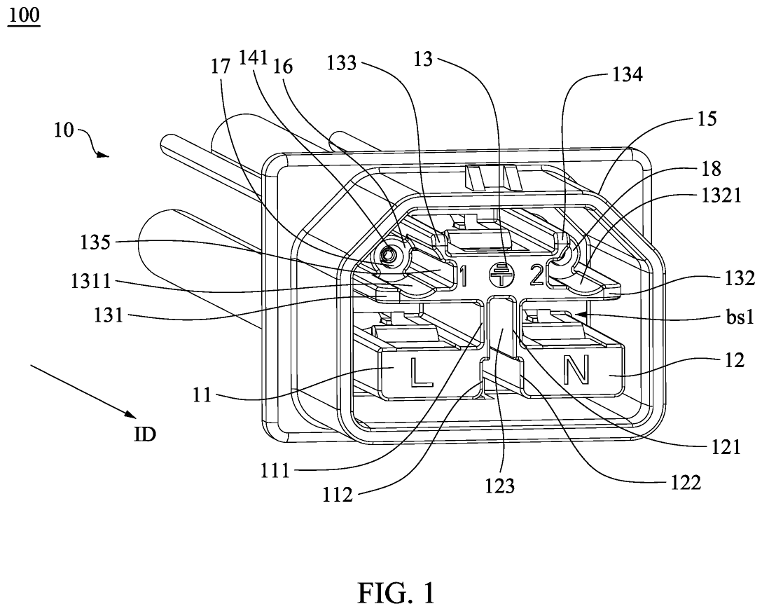

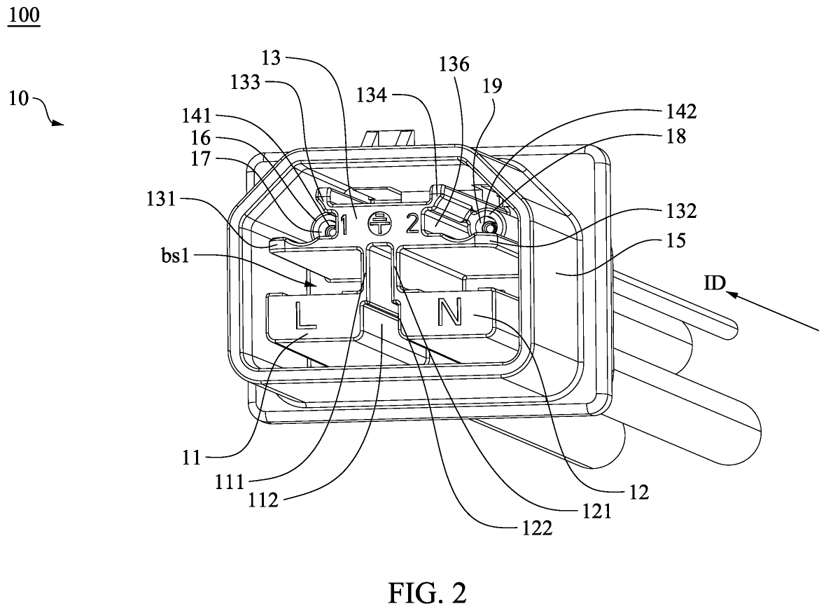

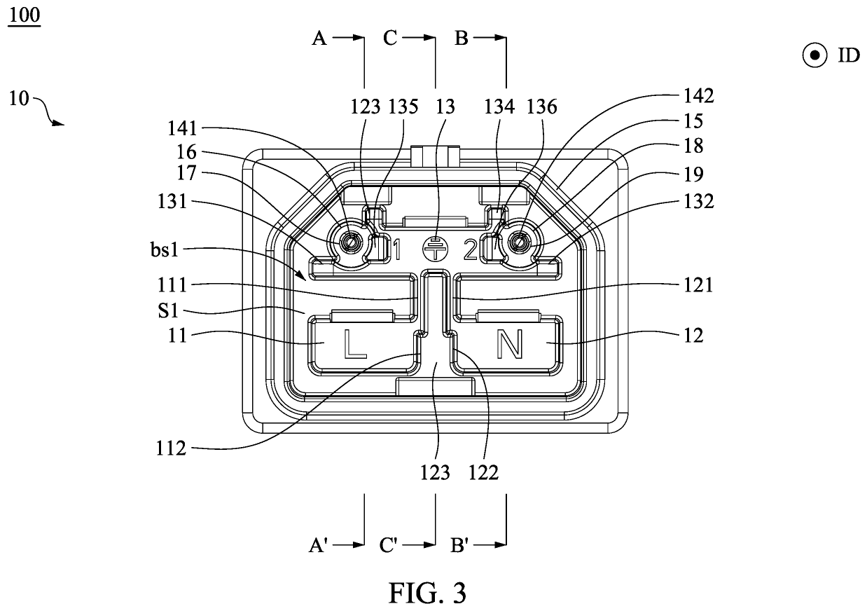

FIG. 1 is a schematic view of a female connector 100 according to some embodiments of the present disclosure. FIG. 2 is a schematic view of the female connector 100 in FIG. 1. FIG. 3 is a side view of the female connector 100 in FIG. 1. Referring to FIG. 1 to FIG. 3, the female connector 100 is provided. The female connector 100 includes a female housing 10. The female housing 10 includes a first terminal support 11, a second terminal support 12, a third terminal support 13, and a plurality of signal terminals. The second terminal support 12 is disposed adjacent to the first terminal support 11. The third terminal support 13 is connected to the first terminal support 11 and the second terminal support 12. A bottom portion of the third terminal support 13 extends laterally on two sides to form a first extension plate 131 and a second extension plate 132, the first extension plate 131 is disposed above the first terminal support 11, and the second extension plate 132 is disposed above the second terminal support 12. The plurality of signal terminals includes a first signal terminal 141 disposed above the first extension plate 131 and a second signal terminal 142 disposed above the second extension plate 132.

Specifically, the first terminal support 11 and the second terminal support 12 are disposed below the third terminal support 13. The first extension plate 131 is disposed above the first terminal support 11, and the second extension plate 132 is disposed above the second terminal support 12.

In an embodiment, the first terminal support 11, the second terminal support 12, the third terminal support 13, the first signal terminal 141, and the second signal terminal 142 are all disposed in the same female housing 10, so that the female connector 100 is capable of simultaneously providing both power transmission and signal transmission functions, thereby reducing the space occupied by the connector within a device. In addition, two sides of the third terminal support 13 are extended to form the first extension plate 131 and the second extension plate 132, and then the first signal terminal 141 and the second signal terminal 142 are respectively disposed above the first extension plate 131 and the second extension plate 132. The first extension plate 131 and the second extension plate 132 respectively isolate the communication space among the first terminal support 11, the second terminal support 12, and the third terminal support 13, which avoids electric arc caused by plugging and unplugging the female connector 100 under power, thereby prevent the signal terminals from being affected and ensuring normal signal transmission.

In an embodiment, in order to better prevent the signal terminals from being affected by arcing and the like, two sides of an upper portion of the third terminal support 13 extend upward to form a first side wall 133 and a second side wall 134, a first gap 135 is formed between the first signal terminal 141 and the third terminal support 13, and a second gap 136 is formed between the second signal terminal 142 and the third terminal support 13. The arrangement of the first side wall 133, the second side wall 134, the first gap 135, and the second gap 136 can isolate the signal terminals from the ground connection terminals.

In an embodiment, the female housing 10 further includes a first protrusion 16 and a second protrusion 18, wherein a first through hole 17 is formed in the first protrusion 16, the first signal terminal 141 is disposed in the first through hole 17, and the first protrusion 16 is connected to the first side wall 133 and the first extension plate 131; wherein a second through hole 19 is formed in the second protrusion 18, the second signal terminal 142 is disposed in the second through hole 19, and the second protrusion 18 is connected to the second side wall 134 and the second extension plate 132.

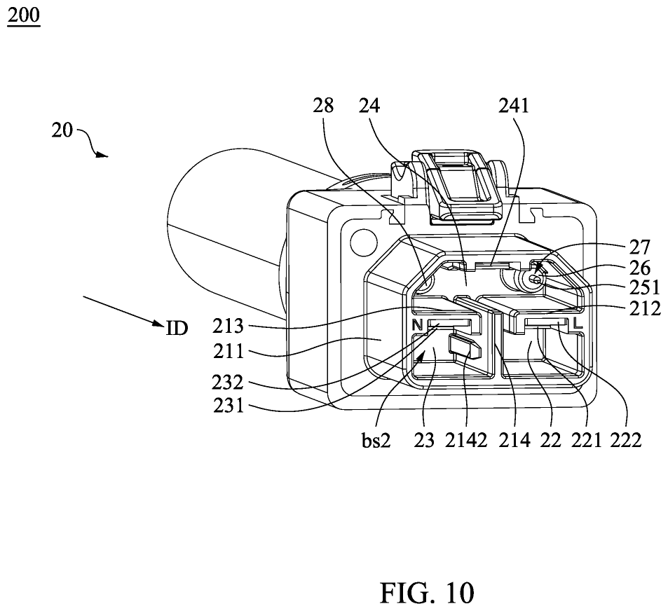

In an embodiment, a front end surface of the first protrusion 16 is recessed relative to a front end surface of the female housing 10, and a front end surface of the second protrusion 18 is recessed relative to the front end surface of the female housing 10. In an embodiment, the front end surface of the female housing 10 could be understood as front end surfaces of the first terminal support 11, second terminal support 12, and third terminal support 13. In other words, a distance between the front end face of each signal terminal and the front end surface of the female housing 10 is greater than a distance between the front end face of each first terminal support 11, the second terminal support 12, and the third terminal support 13 and the female housing 10. With such an arrangement, when a male connector 200 (referring to FIG. 10 to FIG. 13) is inserted into the female connector 100 along an insertion direction ID, the second terminal support 12 and the first terminal support 11 come into contact first (at which time the system is not energized), and the signal terminals come into contact subsequently, whereupon the system is energized after the host obtains a corresponding instruction. During disconnection, the signal terminals are disconnected first, thereby enabling the host to cut off the power in advance, and the neutral terminal block and the line terminal block are subsequently separated. By configuring the signal terminals to be connected later during connection and disconnected earlier during disconnection, a safe hot-unplugging function is indirectly achieved, thereby avoiding electric arc caused by plugging or unplugging the connectors under power.

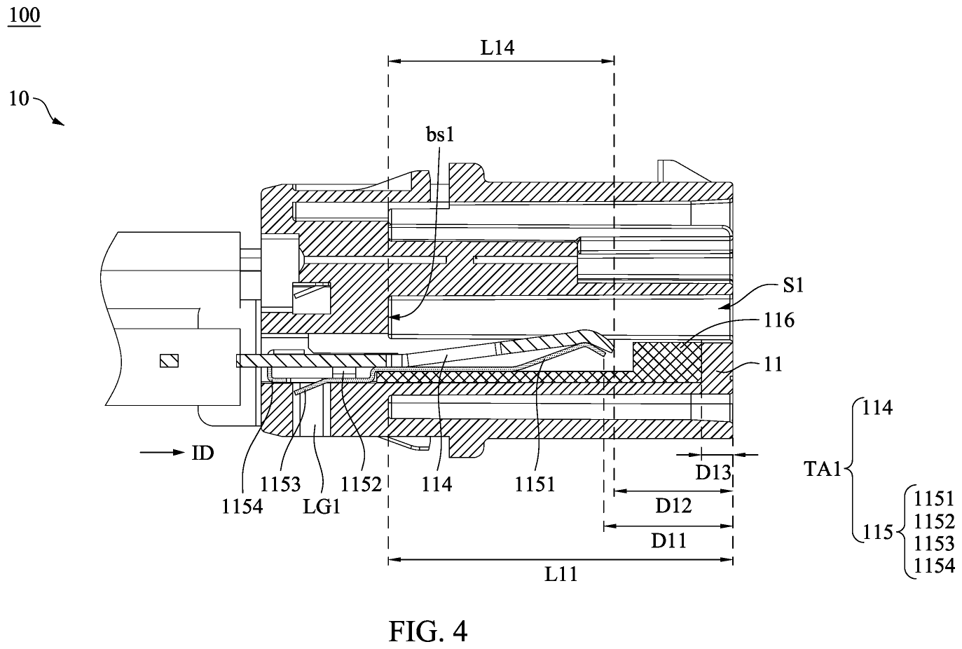

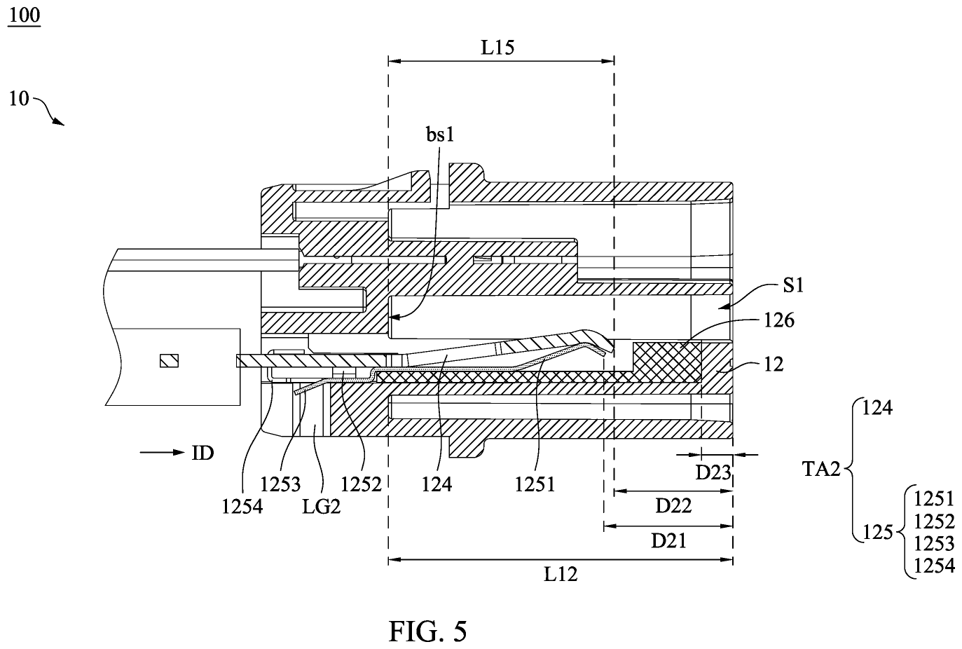

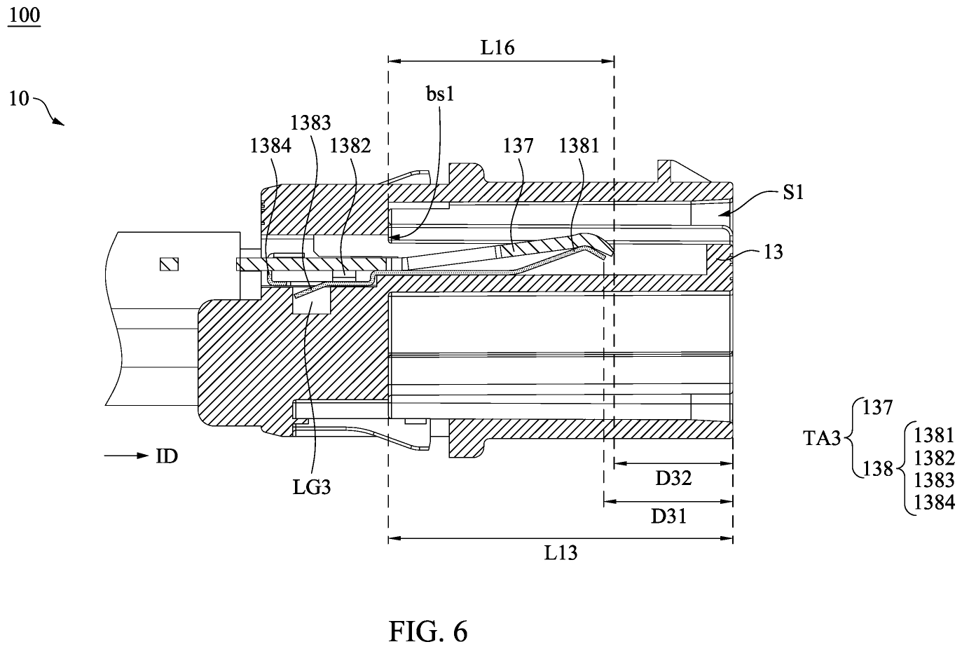

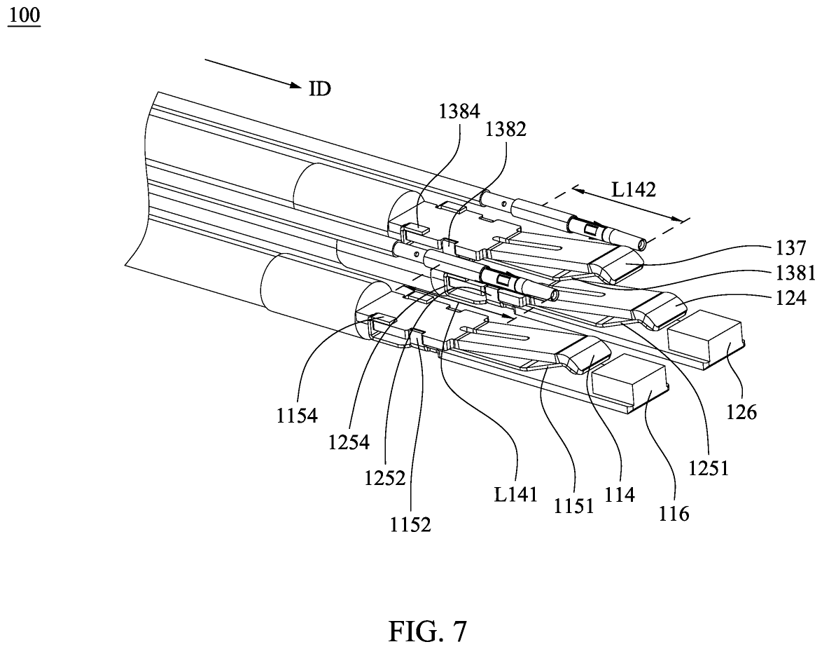

FIG. 4 is a cross-sectional view of the female connector 100 taken along line A-A′ in FIG. 3. FIG. 5 is a cross-sectional view of the female connector 100 taken along line B-B′ in FIG. 3. FIG. 6 is a cross-sectional view of the female connector 100 taken along line C-C′ in FIG. 3. FIG. 7 is a schematic view of the female connector 100 in FIG. 1, in which the housing 10 is omitted and a bottom surface bs1 is shown.

Referring to FIG. 1 to FIG. 7, in an embodiment, along the insertion direction ID of the female connector 100 relative to the male connector 200, the female housing 10 includes an insertion slot S1 having a bottom surface bs1. Within the insertion slot S1, a length L11 (referring to FIG. 4) of the first terminal support 11 is defined by a distance between the bottom surface bs1 and a front end surface of the first terminal support 11, a length L12 (referring to FIG. 5) of the second terminal support 12 is defined by a distance between the bottom surface bs1 and a front end surface of the second terminal support 12, a length L13 (referring to FIG. 6) of the third terminal support 13 is defined by a distance between the bottom surface bs1 and a front end surface of the third terminal support 13, a length L141 (referring to FIG. 7) of the first signal terminal 141 is defined by a distance between the bottom surface bs1 and a front end surface of the first signal terminal 141, a length L142 (referring to FIG. 7) of the second signal terminal 142 is defined by a distance between the bottom surface bs1 and a front end surface of the second signal terminal 142. In an embodiment, the length L141 and L142 of each of the first signal terminal 141 and the second signal terminal 142 is less than the length L11 of the first terminal support 11, less than the length L12 of the second terminal support 12, and less than the length L13 of the third terminal support 13. It should be understood that the bottom surfaces bs1 of the first terminal support 11, the second terminal support 12, and the third terminal support 13 are on the same plane in FIG. 1 to FIG. 6. It could be understood that the “insertion direction ID” herein represents a direction along the insertion slot S1 of the female connector 100 and an insertion slot S2 of the male connector 200, in which the female connector 100 cooperates with the male connector 200. The “insertion slot S1” is in the female housing 10 and configured to accommodate a male housing 20 of the male connector 200.

In some embodiments, each of the lengths L11, L12, and L13 is in a range from 21 mm to 51 mm. Specifically, in the present embodiment, each of the lengths L11, L12, and L13 is substantially 32.8 mm.

In some embodiments, each of the lengths L141 and L142 is in a range from 11 mm to 26 mm. Specifically, in the present embodiment, each of the lengths L141 and L142 is substantially 16.5 mm.

In some embodiments, the length of the signal terminal<the length of the first terminal support or the length of the second terminal support≤the length of the third terminal support. Referring to FIG. 4 to FIG. 6, in an embodiment, the length L11 of the first terminal support 11 is substantially equal to the length L12 of the second terminal support 12, and the length L11 of the first terminal support 11 and the length L12 of the second terminal support 12 are each substantially equal to the length L13 of the third terminal support 13. The first terminal support 11 and the second terminal support 12 are aligned with each other on the mating face.

In an embodiment, because the bottom surfaces bs1 of the first terminal support 11, the second terminal support 12, and the third terminal support 13 may be different, the length L11 of the first terminal support 11 and the length L12 of the second terminal support 12 may each less than the length L13 of the third terminal support 13.

In an embodiment, upper end surfaces of the first extension plate 131 and the second extension plate 132 are respectively recessed to form a first guide recess 1311 and a second guide recess 1321. The first guide recess 1311 and the second guide recess 1321 can guide the signal mating terminals of the female connector, thereby facilitating alignment and connection between the two.

In an embodiment, the first terminal support 11 includes a first inner wall 111, the second terminal support 12 includes a second inner wall 121, and the first inner wall 111 and the second inner wall 121 are disposed facing each other and connected to the third terminal support 13. A third gap 123 is formed between the first inner wall 111 and the second inner wall 121. In order to facilitate better connection between the female connector 100 and the male connector 200 (referring to FIG. 10 to FIG. 13), the first terminal support 11 has a first guide groove 112 on a side toward the second terminal support 12, and the second terminal support 12 has a second guide groove 122 on a side toward the first terminal support 11. The arrangement of the first inner wall 111, the second inner wall 121, and the third gap 123 can effectively isolate the second terminal support 12 from the first terminal support 11.

In an embodiment, the female housing 10 further has an annular outer wall 15, and the first terminal support 11, the second terminal support 12, the third terminal support 13, the first signal terminal 141, and the second signal terminal 142 are disposed within the annular outer wall 15.

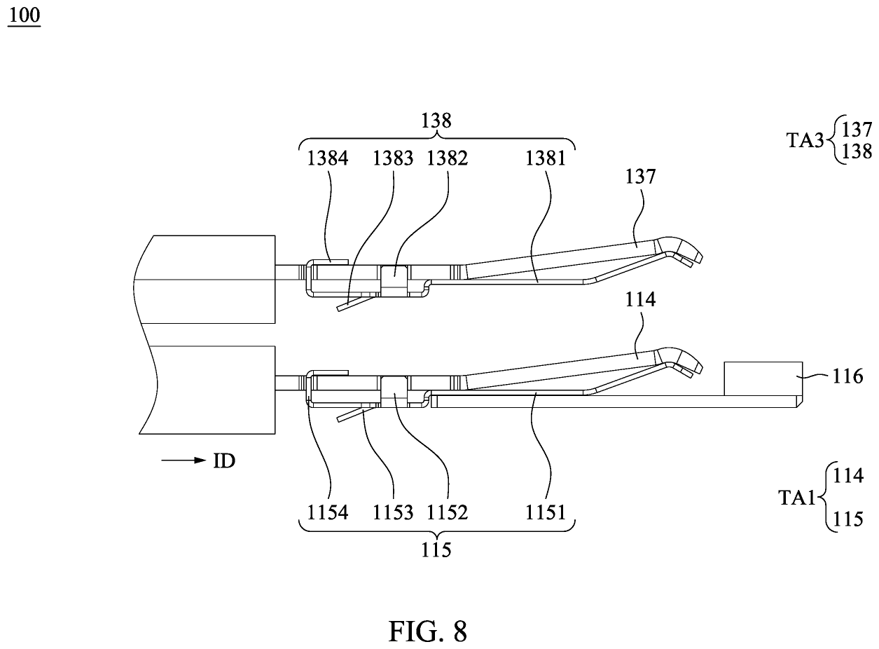

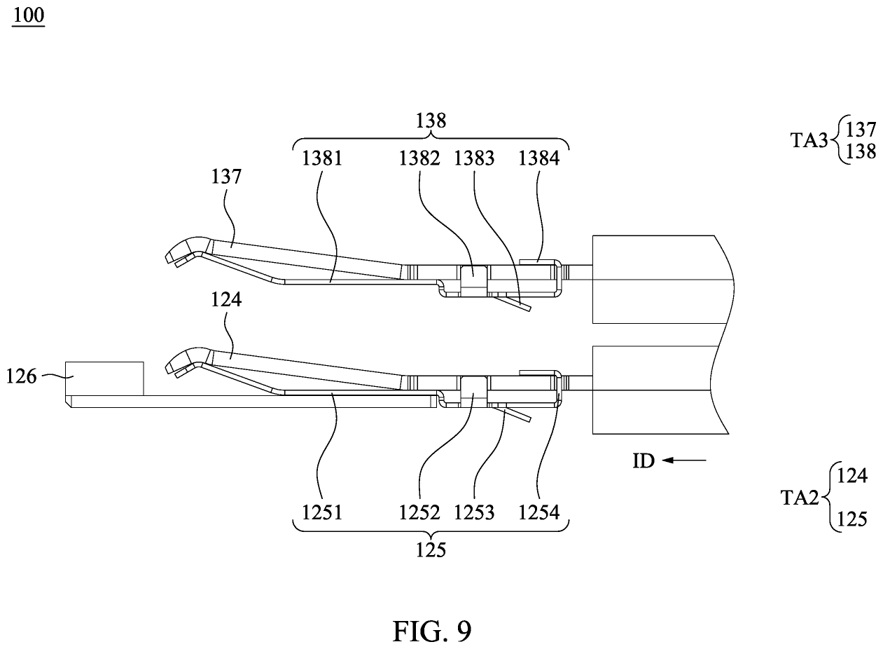

FIG. 8 is a side view of the female connector 100 in FIG. 1, in which the housing 10, the first signal terminal 141, and the second signal terminal 142 are omitted. FIG. 9 is a side view of the female connector 100 in FIG. 1, in which the housing 10, the first signal terminal 141, and the second signal terminal 142 are omitted. Referring to FIG. 4 to FIG. 9, the female connector 100 further includes a plurality of terminal assemblies including a first terminal assembly TA1, a second terminal assembly TA2, and a third terminal assembly TA3 respectively mounted in the first terminal support 11, the second terminal support 12, and the third terminal support 13.

In an embodiment, each of the terminal assemblies TA1, TA2, and TA3 includes a spring member and a supporting member disposed below the spring member, the supporting member includes a main portion, an upward extension portion, a downward extension portion, and an end portion arranged in sequence along the insertion direction ID of the female connector 100.

In an embodiment, the upward extension portion and the end portion are configured to fix the spring member above the supporting member. Specifically, the upward extension portion and the end portion can prevent the spring member from displacement along the insertion direction ID during plugging or unplugging the female connector 100 and the male connector 200.

In an embodiment, the female housing 10 further includes a latching groove, and the downward extension portion is configured to extend into the latching groove to prevent the spring member from displacement along an opposite direction of the insertion direction ID during plugging or unplugging the female connector 100 and the male connector 200.

In an embodiment, the first terminal support 11 is a line terminal support, the second terminal support 12 is a neutral terminal support, the third terminal support 13 is a ground terminal support, the first terminal assembly TA1 is a line terminal assembly, the second terminal assembly TA2 is a neutral terminal assembly, and the third terminal assembly TA3 is a ground terminal assembly.

Referring to FIG. 4 and FIG. 8, in an embodiment, the line terminal assembly includes a spring member 114 and a supporting member 115, the female connector 100 further includes an isolation member 116 on the first terminal support 11, and the supporting member 115 of the line terminal assembly is disposed between the spring member 114 of the line terminal assembly and the isolation member 116.

Referring to FIG. 4, FIG. 7, and FIG. 8, in an embodiment, the supporting member 115 includes a main portion 1151, an upward extension portion 1152, a downward extension portion 1153, and an end portion 1154 arranged in sequence along the insertion direction ID. The main portion 1151 is located between the spring member 114 and an isolation member 116, the upward extension portion 1152 extends upward to a side adjacent to a sidewall of the spring member 114, the downward extension portion 1153 extends downward to a first latching groove LG1 of the housing 10, and the end portion 1154 extends upward to a top surface of the spring member 114. The main portion 1151 is configured to support upward the spring member 114 such that a gap exists between the spring member 114 and the isolation member 116. The upward extension portion 1152, the downward extension portion 1153, and/or the end portion 1154 are configured to prevent the spring member 114 from displacement. In other words, with the arrangement of the supporting member 115, the spring member 114 can avoid backing-up or movement in the housing 10 during plugging or unplugging the connectors.

Referring to FIG. 4, in an embodiment, a first distance between the front end surface of the first terminal support 11 and a front end surface of the supporting member 115 is D11, a second distance between the front end surface of the first terminal support 11 and a front end surface of the spring member 114 is D12, and a third distance between the front end surface of the first terminal support 11 and a front end surface of the isolation member 116 is D13, and D11>D12>D13. When the first distance D11, the second distance D12, and the third distance D13 satisfy the above conditions, the electric arc caused by plugging or unplugging the connectors under power can be prevented. In some embodiments, the isolation member 116 includes an insulating material, such as a ceramic material or a high temperature resistant insulation material, but is not limited thereto. The isolation member 116 is configured to isolate and shield the spring member 114 from directly contacts with the corresponding terminal during the plugging and unplugging process, thereby preventing the female connector 100 and the male connector 200 from being broken, so that the safety performance of the high current connectors can be higher. Specifically, during the plugging process, the corresponding terminal of the male connector 200 comes into contact the isolation member 116 first, and the spring member 114 comes into contact subsequently, thereby avoiding electric arc caused by plugging the connectors.

Referring to FIG. 5 and FIG. 9, in an embodiment, the neutral terminal assembly includes a spring member 124 and a supporting member 125, the female connector 100 further includes an isolation member 126 on the second terminal support 12, and the supporting member 125 of the neutral terminal assembly is disposed between the spring member 124 of the neutral terminal assembly and the isolation member 126.

Referring to FIG. 5, FIG. 7, and FIG. 9, in an embodiment, the supporting member 125 includes a main portion 1251, an upward extension portion 1252, a downward extension portion 1253, and an end portion 1254 arranged in sequence along the insertion direction ID. The main portion 1251 is located between the spring member 124 and an isolation member 126, the upward extension portion 1252 extends upward to a side adjacent to a sidewall of the spring member 124, the downward extension portion 1253 extends downward to a second latching groove LG2 of the housing 10, and the end portion 1254 extends upward to a top surface of the spring member 124. The main portion 1251 is configured to support upward the spring member 124 such that a gap exists between the spring member 124 and the isolation member 126. The upward extension portion 1252, the downward extension portion 1253, and/or the end portion 1254 are configured to prevent the spring member 124 from displacement. In other words, with the arrangement of the supporting member 125, the spring member 124 can avoid backing-up or movement in the housing 10 during plugging or unplugging the connectors.

Referring to FIG. 5, in an embodiment, a first distance between the front end surface of the second terminal support 12 and a front end surface of the supporting member 125 is D21, a second distance between the front end surface of the second terminal support 12 and a front end surface of the spring member 124 is D22, and a third distance between the front end surface of the second terminal support 12 and a front end surface of the isolation member 126 is D23, and D21>D22>D23. When the first distance D21, the second distance D22, and the third distance D23 satisfy the above conditions, the electric arc caused by plugging or unplugging the connectors under power can be prevented. In some embodiments, the isolation member 126 includes an insulating material, such as a ceramic material or a high temperature resistant insulation material, but is not limited thereto. The isolation member 126 is configured to isolate and shield the spring member 124 from directly contacts with the corresponding terminal during the plugging and unplugging process, thereby preventing the female connector 100 and the male connector 200 from being broken, so that the safety performance of the high current connectors can be higher. Specifically, during the plugging process, the corresponding terminal comes into contact the isolation member 126 first, and the spring member 124 comes into contact subsequently, thereby avoiding electric arc caused by plugging the connectors.

Referring to FIG. 6 and FIG. 8, in an embodiment, the ground terminal assembly a spring member 137 and a supporting member 138 disposed between the spring member 137 of the ground terminal assembly and the third terminal support 13.

Referring to FIG. 6 to FIG. 8, in an embodiment, the supporting member 138 includes a main portion 1381, an upward extension portion 1382, a downward extension portion 1383, and an end portion 1384 arranged in sequence along the insertion direction ID. The upward extension portion 1382 extends upward to a side adjacent to a sidewall of the spring member 137, the downward extension portion 1383 extends downward to a third latching groove LG3 of the housing 10, and the end portion 1384 extends upward to a top surface of the spring member 137. The main portion 1381 is configured to support upward the spring member 137 such that a gap exists between the spring member 137 and the third terminal support 13. The upward extension portion 1382, the downward extension portion 1383, and/or the end portion 1384 are configured to prevent the spring member 137 from displacement. In other words, with the arrangement of the supporting member 138, the spring member 137 can avoid backing-up or movement in the housing 10 during plugging or unplugging the connectors.

Specifically, the female housing 10 is provided with a plurality of latching grooves LG1, LG2, and LG3 within the insertion slot S1. These latching grooves are located at a position rearward relative to the bottom surface bs1 (i.e., extending in a direction opposite to the insertion direction ID). When the terminal assemblies are mounted, their downward extension portions 1153, 1253, 1383 extend into and engage with the corresponding latching grooves.

Referring to FIG. 6, in an embodiment, a first distance between the front end surface of the third terminal support 13 and a front end surface of the supporting member 138 is D31, a second distance between the front end surface of the third terminal support 13 and a front end surface of the spring member 137 is D32, and D31>D32.

Referring to FIG. 4 to FIG. 6, along the insertion direction ID, within the insertion slot S1, a length L14 of the first terminal assembly TA1 is defined by a distance between the front end surface of the spring member 114 and the bottom surface bs1, a length L15 of the second terminal assembly TA2 is defined by a distance between the front end surface of the spring member 124 and the bottom surface bs1, and a length L16 of the third terminal assembly TA3 is defined by a distance between the front end surface of the spring member 137 and the bottom surface bs1. In this embodiment, each of the length L141 of the first signal terminal 141 and the length L142 of the second signal terminal 142 is less than each of the length L14 of the first terminal assembly TA1, the length L15 of the second terminal assembly TA2, and the length L16 of the third terminal assembly TA3.

In some embodiments, each of the lengths L14, L15, and L16 is in a range from 14 mm to 33 mm. Specifically, in the present embodiment, each of the lengths L14, L15, and L16 is substantially 21.5 mm.

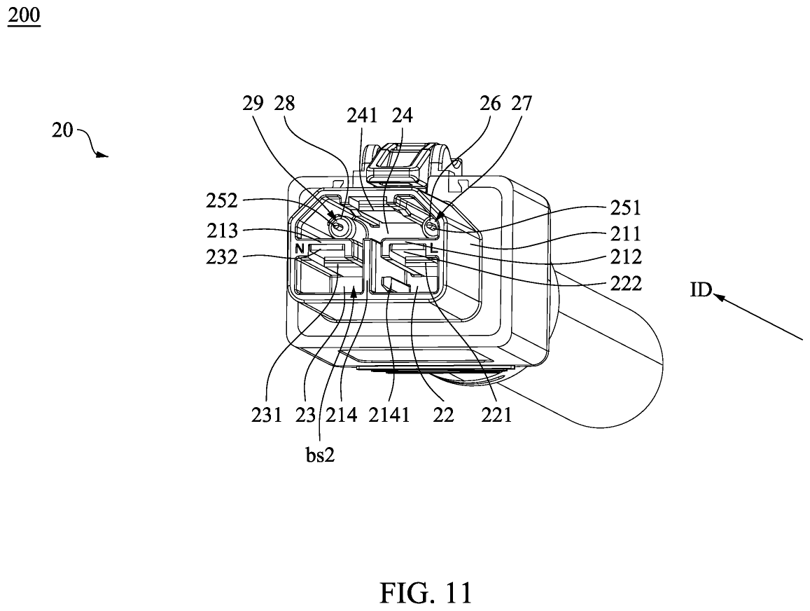

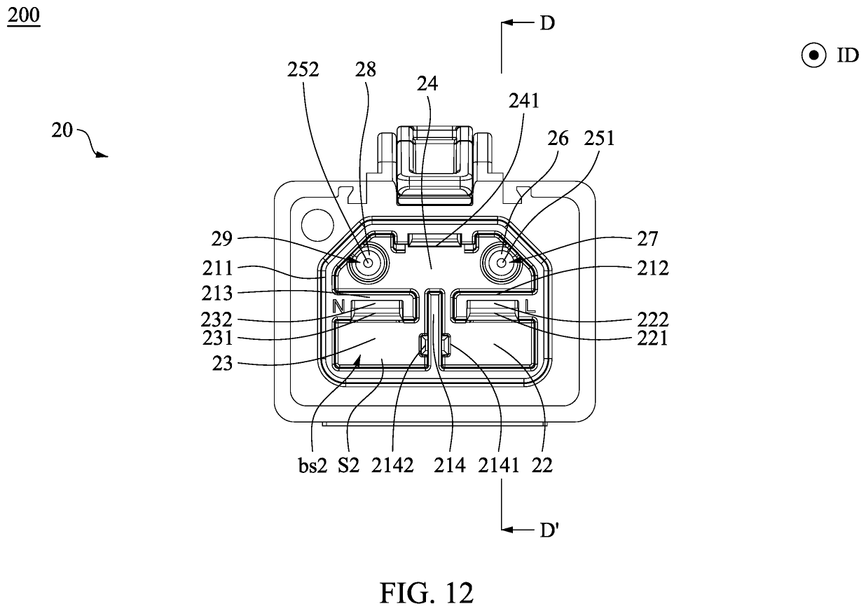

FIG. 10 is a schematic view of a male connector 200 according to some embodiments of the present disclosure. FIG. 11 is a schematic view of the male connector 200 in FIG. 10. FIG. 12 is a side view of the male connector 200 in FIG. 10. Referring to FIG. 10 to FIG. 12, the male connector 200 is provided. The male connector 200 includes a male housing 20, a plurality of conductive terminals, and a plurality of signal terminals. The male housing 20 includes a first terminal cavity 22, a second terminal cavity 23, and a third terminal cavity 24. The second terminal cavity 23 is arranged beside the first terminal cavity 22. The third terminal cavity 24 is communicated with the first terminal cavity 22 and the second terminal cavity 23. The plurality of conductive terminals includes a first conductive terminal 221 disposed in the first terminal cavity 22, a second conductive terminal 231 disposed in the second terminal cavity 23, and a third conductive terminal 241 disposed in the third terminal cavity 24. The plurality of signal terminals includes a first signal terminal 251 and a second signal terminal 252 in the third terminal cavity 24, wherein the first signal terminal 251 and the second signal terminal 252 are disposed on opposite sides of the third conductive terminal 241.

In an embodiment, the first terminal cavity 22 is a line terminal cavity, the second terminal cavity 23 is a neutral terminal cavity, the third terminal cavity 24 is a ground terminal cavity, the first conductive terminal 221 is a line conductive terminal, the second conductive terminal 231 is a neutral conductive terminal, and the third conductive terminal 241 is a ground conductive terminal. In an embodiment, a length of the third conductive terminal 241 is greater than the length of each of the second conductive terminal 231 and the first conductive terminal 221.

In an embodiment, the first signal terminal 251 is disposed above the first terminal cavity 22, and the second signal terminal 252 is disposed above the second terminal cavity 23.

In an embodiment, the male housing 20 further includes a first protrusion 26 and a second protrusion 28, wherein a first through hole 27 is formed in the first protrusion 26, the first signal terminal 251 is disposed in the first through hole 27, a second through hole 29 is formed in the second protrusion 28, and the second signal terminal 252 is disposed in the second through hole 29.

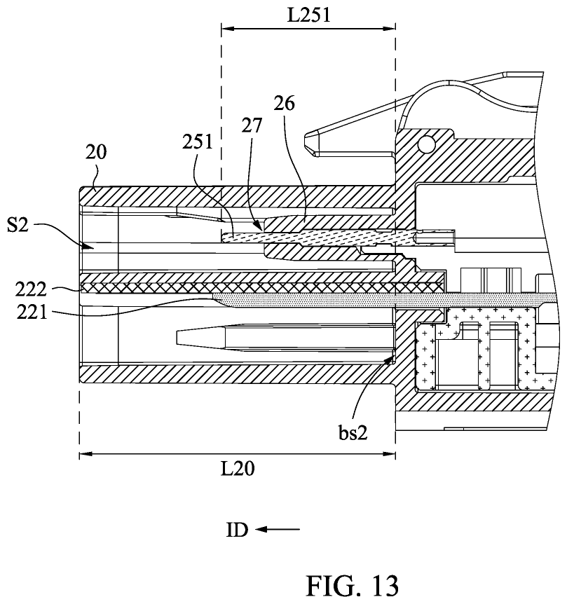

FIG. 13 is a cross-sectional view of the male connector 200 taken along line D-D′ in FIG. 12. Referring to FIG. 10 to FIG. 13, in an embodiment, along the insertion direction ID of the male connector 200 relative to the female connector 100, the male housing 20 includes an insertion slot S2 having a bottom surface bs2, a length L20 (referring to FIG. 13) of the male housing 20 is defined by a distance between the bottom surface bs2 and a front end surface of the male housing 20, a length L251 (referring to FIG. 13) of the first signal terminal 251 is defined by a distance between the bottom surface bs2 and a front end surface of the first signal terminal 251, and a length of the second signal terminal 252 is defined by a distance between the bottom surface bs2 and a front end surface of the second signal terminal 252. In an embodiment, the length (i.e., the lengths L251 and L252) of each of the first signal terminal 251 and the second signal terminal 252 is less than the length L20 of the male housing 20.

In an embodiment, the male housing 20 includes an annular outer wall 211, a first terminal fixing plate 212, and a second terminal fixing plate 213, wherein the first terminal fixing plate 212 and the second terminal fixing plate 213 are connected to an inner side of the annular outer wall 211. In an embodiment, the first terminal fixing plate 212 is disposed between the first terminal cavity 22 and the third terminal cavity 24, and the first conductive terminal 221 is mounted on a lower end surface of the first terminal fixing plate 212. In an embodiment, the second terminal fixing plate 213 is disposed between the second terminal cavity 23 and the third terminal cavity 24, the second conductive terminal 231 is mounted on a lower end surface of the second terminal fixing plate 213, and the third conductive terminal 241 is mounted in the inner side of annular outer wall 211.

In an embodiment, the male connector 200 further includes a first isolation member 222 and a second isolation member 232, wherein the first isolation member 222 is disposed between the first conductive terminal 221 and the first terminal fixing plate 212, the second isolation member 232 is disposed between the second terminal fixing plate 213 and the second conductive terminal 231, a front end surface of the first conductive terminal 221 is recessed relative to a front end surface of the first isolation member 222, and a front end surface of the second conductive terminal 231 is recessed relative to a front end surface of the second isolation member 232.

In an embodiment, a length of the first isolation member 222 is greater than a length of the first conductive terminal 221, and a length of the second isolation member 232 is greater than a length of the second conductive terminal 231. In some embodiments, the first isolation member 222 and the second isolation member 232 include insulating materials, such as ceramic materials or high temperature resistant insulation materials, but are not limited thereto. The first isolation member 222 and the second isolation member 232 are configured to isolate and shield the first conductive terminal 221 and the second conductive terminal 231 from directly contacts with the corresponding terminal during the plugging and unplugging process, thereby preventing the female connector 100 and the male connector 200 from being broken, so that the safety performance of the high current connectors can be higher. Specifically, during the plugging process, the corresponding terminals of the female connector 100 come into contact the first isolation member 222 and the second isolation member 232 first, and the first conductive terminal 221 and the second conductive terminal 231 come into contact subsequently, thereby avoiding electric arc caused by plugging the connectors.

In an embodiment, the male housing 20 further includes an isolation plate 214 connected to the inner side of the annular outer wall 211, the isolation plate 214 is disposed between the first terminal cavity 22 and the second terminal cavity 23, and a first guide block 2141 and a second guide block 2142 are disposed on opposite sides of the isolation plate 214. The first guide block 2141 and the second guide block 2142 of the male connector 200 cooperate with the first guide groove 112 and the second guide groove 122 of the female connector 100.

In summary, the first terminal support 11, the second terminal support 12, the third terminal support 13, and the plurality of signal terminals are all disposed in the same female housing 10, so that the female connector 100 is capable of simultaneously providing both power transmission and signal transmission functions. In addition, the signal terminals are disposed in the third terminal cavity 24, so that the male connector 200 is capable of simultaneously providing both power transmission and signal transmission functions. Therefore, the present disclosure enables the connectors to perform both power transmission and signal transmission functions through structural design, thereby reducing the space occupied by the connectors within a device.

The above are only exemplary embodiments of the present disclosure and do not limit the scope of the patent of the present disclosure. Any equivalent structural transformations made under the technical concept of the present disclosure using the contents of the description and drawings of the present disclosure, or direct/indirect applications in other related technical fields, are included in the scope of patent protection of the present disclosure.

What is claimed is:

1. A female connector, comprising:
a female housing, comprising:
a first terminal support;
a second terminal support disposed adjacent to the first terminal support;
a third terminal support connected to the first terminal support and the second terminal support; wherein a bottom portion of the third terminal support extends laterally on two sides to form a first extension plate and a second extension plate, the first extension plate being disposed above first terminal support, and the second extension plate being disposed above the second terminal support; and
a plurality of signal terminals comprising a first signal terminal disposed above the first extension plate and a second signal terminal disposed above the second extension plate.

2. The female connector of claim 1, wherein two sides of an upper portion of the third terminal support extend upward to form a first side wall and a second side wall, a first gap is formed between the first signal terminal and the third terminal support, and a second gap is formed between the second signal terminal and the third terminal support.

3. The female connector of claim 2, wherein the female housing further comprises a first protrusion and a second protrusion, wherein a first through hole is formed in the first protrusion, the first signal terminal is disposed in the first through hole, and the first protrusion is connected to the first side wall and the first extension plate; and
wherein a second through hole is formed in the second protrusion, the second signal terminal is disposed in the second through hole, and the second protrusion is connected to the second side wall and the second extension plate.

4. The female connector of claim 3, wherein a front end surface of the first protrusion is recessed relative to a front end surface of the female housing, and a front end surface of the second protrusion is recessed relative to the front end surface of the female housing.

5. The female connector of claim 1, wherein along an insertion direction of the female connector, the female housing comprises an insertion slot having a bottom surface, a length of the first terminal support is defined by a distance between the bottom surface and a front end surface of the first terminal support, a length of the second terminal support is defined by a distance between the bottom surface and a front end surface of the second terminal support, a length of the third terminal support is defined by a distance between the bottom surface and a front end surface of the third terminal support, a length of the first signal terminal is defined by a distance between the bottom surface and a front end surface of the first signal terminal, a length of the second signal terminal is defined by a distance between the bottom surface and a front end surface of the second signal terminal; and
wherein the length of each of the first signal terminal and the second signal terminal is less than the length of the first terminal support, the second terminal support, and the third terminal support.

6. The female connector of claim 1, wherein upper end surfaces of the first extension plate and the second extension plate are respectively recessed to form a first guide recess and a second guide recess.

7. The female connector of claim 1, wherein the first terminal support comprises a first inner wall, the second terminal support comprises a second inner wall, and the first inner wall and the second inner wall are disposed facing each other and connected to the third terminal support, and
wherein a third gap is formed between the first inner wall and the second inner wall, the first terminal support has a first guide groove on a side toward the second terminal support, and the second terminal support has a second guide groove on a side toward the first terminal support.

8. The female connector of claim 1, wherein the female housing further has an annular outer wall, and the first terminal support, the second terminal support, the third terminal support, the first signal terminal, and the second signal terminal are disposed within the annular outer wall.

9. The female connector of claim 1, further comprising a plurality of terminal assemblies comprising a first terminal assembly, a second terminal assembly, and a third terminal assembly respectively mounted in the first terminal support, the second terminal support, and the third terminal support;
wherein each of the terminal assemblies comprises a spring member and a supporting member disposed below the spring member, the supporting member comprises a main portion, an upward extension portion, a downward extension portion, and an end portion arranged in sequence along an insertion direction of the female connector; and
wherein the upward extension portion and the end portion are configured to fix the spring member above the supporting member.

10. The female connector of claim 9, wherein the female housing further comprises a latching groove, and the downward extension portion is configured to extend into the latching groove to prevent the spring member from displacement along an opposite direction of the insertion direction.

11. The female connector of claim 9, wherein the first terminal support is a line terminal support, the second terminal support is a neutral terminal support, the third terminal support is a ground terminal support, the first terminal assembly is a line terminal assembly, the second terminal assembly is a neutral terminal assembly, and the third terminal assembly is a ground terminal assembly.

12. The female connector of claim 11, further comprising an isolation member on the first terminal support, and the supporting member of the line terminal assembly is disposed between the spring member of the line terminal assembly and the isolation member; and
wherein a first distance is defined between a front end surface of the first terminal support and a front end surface of the supporting member of the line terminal assembly, a second distance is defined between the front end surface of the first terminal support and a front end surface of the spring member of the line terminal assembly, and a third distance is defined between the front end surface of the first terminal support and a front end surface of the isolation member; and
wherein the first distance is greater than the second distance, and the second distance is greater than the third distance.

13. The female connector of claim 11, further comprising an isolation member on the second terminal support, and the supporting member of the neutral terminal assembly is disposed between the spring member of the neutral terminal assembly and the isolation member; and
wherein a first distance is defined between a front end surface of the second terminal support and a front end surface of the supporting member of the neutral terminal assembly, a second distance is defined between the front end surface of the second terminal support and a front end surface of the spring member of the neutral terminal assembly, and a third distance is defined between the front end surface of the second terminal support and a front end surface of the isolation member; and
wherein the first distance is greater than the second distance, and the second distance is greater than the third distance.

14. The female connector of claim 11, wherein the supporting member of the ground terminal assembly disposed between a spring member of the ground terminal assembly and the third terminal support; and
wherein a first distance is defined between a front end surface of the third terminal support and a front end surface of the supporting member of the ground terminal assembly, a second distance is defined between the front end surface of the third terminal support and a front end surface of the spring member of the ground terminal assembly, and the first distance is greater than the second distance.

15. A male connector, comprising:
a male housing, comprising:
a first terminal cavity;
a second terminal cavity arranged beside the first terminal cavity; and
a third terminal cavity communicating with the first terminal cavity and the second terminal cavity;
a plurality of conductive terminals comprising a first conductive terminal disposed in the first terminal cavity, a second conductive terminal disposed in the second terminal cavity, and a third conductive terminal disposed in the third terminal cavity; and
a plurality of signal terminals comprising a first signal terminal and a second signal terminal in the third terminal cavity, wherein the first signal terminal and the second signal terminal are disposed on opposite sides of the third conductive terminal.

16. The male connector of claim 15, wherein the first terminal cavity is a line terminal cavity, the second terminal cavity is a neutral terminal cavity, the third terminal cavity is a ground terminal cavity, the first conductive terminal is a line conductive terminal, the second conductive terminal is a neutral conductive terminal, and the third conductive terminal is a ground conductive terminal.

17. The male connector of claim 15, wherein the first signal terminal is disposed above the first terminal cavity, and the second signal terminal is disposed above the second terminal cavity; and
wherein the male housing further comprises a first protrusion and a second protrusion, wherein a first through hole is formed in the first protrusion, the first signal terminal is disposed in the first through hole, a second through hole is formed in the second protrusion, and the second signal terminal is disposed in the second through hole.

18. The male connector of claim 15, wherein the male housing comprises an annular outer wall, a first terminal fixing plate, and a second terminal fixing plate, wherein the first terminal fixing plate and the second terminal fixing plate are connected to an inner side of the annular outer wall;
wherein the first terminal fixing plate is disposed between the first terminal cavity and the third terminal cavity, and the first conductive terminal is mounted on a lower end surface of the first terminal fixing plate; and
wherein the second terminal fixing plate is disposed between the second terminal cavity and the third terminal cavity, the second conductive terminal is mounted on a lower end surface of the second terminal fixing plate, and the third conductive terminal is mounted in the inner side of annular outer wall.

19. The male connector of claim 18, further comprising a first isolation member and a second isolation member, wherein the first isolation member is disposed between the first conductive terminal and the first terminal fixing plate, the second isolation member is disposed between the second terminal fixing plate and the second conductive terminal, a front end surface of the first conductive terminal is recessed relative to a front end surface of the first isolation member, and a front end surface of the second conductive terminal is recessed relative to a front end surface of the second isolation member.

20. The male connector of claim 19, wherein the male housing further comprises an isolation plate connected to the inner side of the annular outer wall, the isolation plate is disposed between the first terminal cavity and the second terminal cavity, and a first guide block and a second guide block are disposed on opposite sides of the isolation plate.
